(19) United States
(12) Patent Application Publication
(10) Pub. No.: US 2022/0300771 A1
(43) Pub. Date: Sep. 22, 2022

(54) CLASSIFICATION SYSTEM AND METHOD OF INFORMATION IN IMAGE

(71) Applicants: Inventec (Pudong) Technology Corporation, Shanghai (CN); INVENTEC CORPORATION, Taipei (TW)

(72) Inventors: Trista Pei-Chun Chen, Taipei (TW); Po Hsuan Huang, Taipei (TW)

(21) Appl. No.: 17/341,758

(22) Filed: Jun. 8, 2021

(30) Foreign Application Priority Data
Mar. 16, 2021 (CN) 202110282440.0

(51) Int. Cl. G06K 9/62; G06N 3/04

(52) U.S. Cl. CPC G06K 9/6268; G06K 9/6228; G06K 9/6288; G06N 3/0454

(57) ABSTRACT

A classification method of information in image comprises receiving an input image and generating a plurality of shared feature maps by a convolutional neural network; generating a plurality of attention maps according to the plurality of shared feature maps by an attention network; selecting at least two of the plurality of attention maps to perform a fusion operation to generate a fusion map by a fusion circuit; and generating a classification result according to the fusion map by a classifier.

### CROSS-REFERENCE TO RELATED APPLICATIONS

This non-provisional application claims priority under 35 U.S.C. § 119(a) on Patent Application No(s). 2021102824400 filed in China on Mar. 16, 2021, the entire contents of which are hereby incorporated by reference.

### BACKGROUND

### 1. Technical Field

This disclosure relates to artificial intelligence and machine learning, and particularly to a classification system and method of information in image.

### 2. Related Art

Artificial intelligence (AI) has shown promising results in simulating human brains in understanding, reasoning, planning, communication, and perception through learning from data. Therefore, AI-assisted diagnosis tools with medical images, such as X-ray, Computed Tomography (CT), Magnetic Resonance Imaging (MRI), and color images, have been proposed in many studies, and most of them focused on diagnosing only specific symptoms.

To perform different diagnosis tasks, one would need to design and train different models. Given a system performing multiple diagnosis tasks, the model's complexity or parameter size is proportional to the number of diagnosis tasks the system needs to perform Therefore, the model generated by this approach is usually too big with a lot of parameters and easily becomes overfitting with a small amount of training data.

To perform different diagnosis tasks, another approach is hard parameter sharing, which shares all convolution layers of the model and uses different task-specific classifiers or regressors at the end of the neural network. However, the model generated by this approach is too general that the shared convolution layers may fail to capture the subtle features required for the individual tasks.

### SUMMARY

Accordingly, the present disclosure proposes a classification system and method of information in image. In order to make the artificial intelligence model more general and leverage the relationship between related symptoms, the framework corresponding to the classification system proposed in the present disclosure may learn all related symptoms at the same time and is also specific enough to evaluate each task.

According to one or more embodiment of this disclosure, a classification method of information in image comprising: obtaining an input image by a convolution neural network and generating a plurality of shared feature maps; generating a plurality of first attention maps by a first attention network according to the plurality of shared feature maps; selecting at least two of the plurality of first attention maps to perform a first fusion operation to generate a first fusion map by a first fusion circuit; and generating a first classification result according to the first fusion map by a first classifier.

According to one or more embodiment of this disclosure, a classification method of information in image comprising: obtaining an input image by a first convolution layer; performing a convolution operation to generate a first feature map according to the input image by the first convolution layer; performing an attention operation to generate a first attention map by a first attention circuit according to the first feature map; performing the convolution operation to generate a second feature map according to the first feature map by a second convolution layer; performing another attention operation to generate a second attention map according to the second feature map and the first attention map by a second attention circuit; performing the convolution operation to generate a third feature map according to the second feature map by a third convolution layer; performing said another attention operation to generate a third attention map according to the third feature map and the second attention map by a third attention circuit; selecting at least two of the first attention map, the second attention map, and the third attention map to perform a fusion operation to generate a fusion map by a fusion circuit; and generating a classification result according to the fusion map by a classifier.

According to one or more embodiment of this disclosure, a classification system of information in image comprising: a first convolution layer obtaining an input image and performing a convolution operation to generate a first feature map according to the input image; a second convolution layer communicably connecting to the first convolution layer and performing the convolution operation to generate a second feature map according to the first feature map; a third convolution layer communicably connecting to the second convolution layer and performing the convolution operation to generate a third feature map according to the second feature map; a first attention circuit communicably connecting to the first convolution layer and performing an attention operation to generate a first attention map according to the first feature map; a second attention circuit communicably connecting to the second convolution layer and the first attention circuit, and performing another attention operation to generate a second attention map according to the second feature map and the first attention map; a third attention circuit communicably connecting to the third convolution layer and the second attention circuit, and performing said another attention operation to generate a third attention map according to the third feature map and the second attention map; a fusion circuit at least communicably connecting to at least two of the first attention circuit, the second attention circuit and the third attention circuit, and performing a fusion operation to generate a fusion map at least according to at least two of the first attention map, the second attention map and the third attention map; and a classifier communicably connecting to the fusion circuit and generating a classification result according to the fusion map.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a framework diagram of a classification system of information in image according to an embodiment of the present disclosure;

FIG. 2 is a flowchart of a classification method of information in image according to an embodiment of the present disclosure;

FIG. 3 shows a detailed framework diagram of a sub-architecture in FIG. 1 as an example;

FIG. 4 is a flowchart of a classification method of information in image according to an embodiment of the present disclosure;

FIG. 5 is a flowchart of the attention operation;

FIG. 6 is a flowchart of the dimension adjustment operation; and

FIG. 7 is a schematic diagram of an embodiment of the fusion operation.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The classification system and method of information in image proposed in the present disclosure are configured to perform classifications on a single medical image for multiple tasks. For example, when the present disclosure is applied to a mammogram, except performing a diagnosis indicating whether the tumor is benign or malignant, the present disclosure may also output a plurality of classification results listed in Table 1 below.

TABLE 1

| Tasks | Output |
|---|---|
| Diagnosis | malignant/benign |
| Sign | none |
| | circumscribed |
| | speculated |
| | micro-calcification |
| | distortion |
| | asymmetric density |
| Suspicion | normal |
| | benign |
| | probably benign |
| | suspicious |
| | malignant |
| Conspicuity | not visible |
| | barely visible |
| | visible, not clear |
| | clearly visible |
| Breast density | 0-100% (Visual Analogue Scale) |

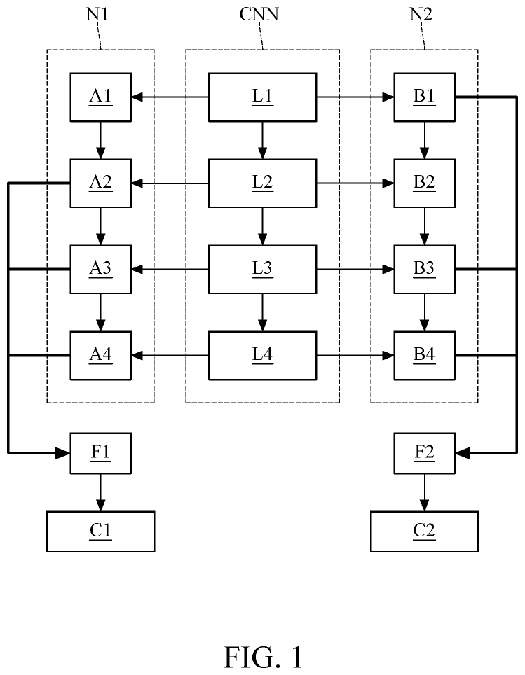

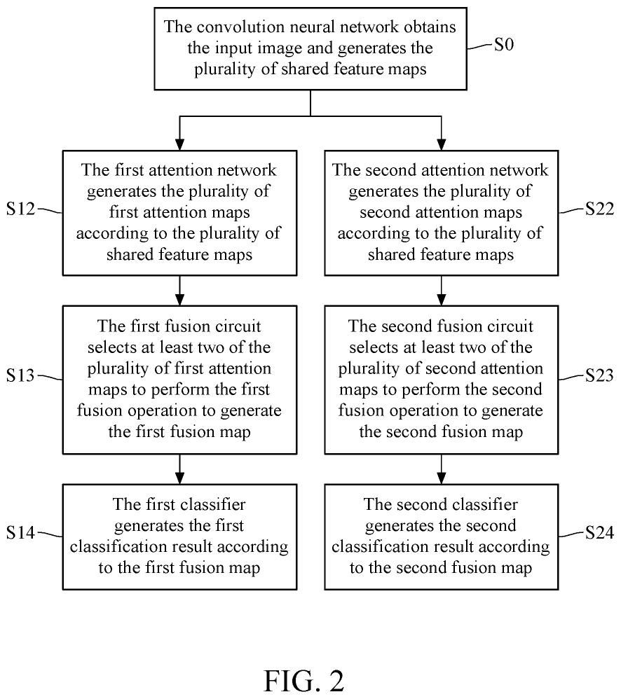

FIG. 1 is a framework diagram of a classification system of information in image according to an embodiment of the present disclosure, this framework is adapted to two classification tasks. FIG. 2 is a flowchart of a classification method of information in image according to an embodiment of the present disclosure and this flowchart corresponds to the framework diagram of FIG. 1.

FIG. 1 shows a convolution neural network CNN including a plurality of convolution layers L1-L4, a first attention network N1 including a plurality of attention circuits A1-A4, a second attention network N2 including a plurality of attention circuits B1-B4, a first fusion circuit F1, a second fusion circuit F2, a first classifier C1 and a second classifier C2. The arrow connecting each block in FIG. 1 represents the data flow outputted by this block.

A sub-architecture composed of the convolutional neural network CNN, the first attention network N1, the first fusion circuit F1, and the first classifier C1 may handle the first classification task. A sub-architecture composed of the convolutional neural network CNN, the second attention network N2, the second fusion circuit F2, and the second classifier C2 may handle the second classification task. One of the classification tasks can be binary classification, such as “malignant” or “benign” as shown in Table 1. Another one of the classification tasks can be multiple classification, such as multiple output results corresponding to the task “sign” shown in Table 1. The present disclosure applies the attention network respectively to the above two sub-architectures, therefore, the present disclosure may share features among classification tasks and find differences between classification tasks.

Please refer to FIG. 2. In step S0, the convolution neural network CNN obtains an input image and generates a plurality of shared feature maps. Specifically, the convolution neural network CNN obtains the external input image, such as the X-ray image of mammography, through the convolution layer L1. The convolution neural network CNN may extract multiple features of the input image through the convolution layers L1-L4. Since the feature extraction of images using the convolution neural network CNN is common knowledge, the detailed steps of feature extraction are not described here.

In step S12, the first attention network N1 generates a plurality of attention maps according to the plurality of shared feature maps. For example, the convolution layer (hidden layer) L1 generates a shared feature map and sends the shared feature map to the attention circuit A1. The attention circuit A1 generates a first attention map according to the shared feature map and sends the first attention map to the attention circuit A2. The data path between the remaining convolution layers L2-L4 and attention circuits A2-A4 may be deduced based on the aforementioned example.

It should be noticed that there are one-to-one correspondences between the attention circuits A1-A4 and the convolution layers L1-L4. Similarly, there are one-to-one correspondences between the attention circuits B1-B4 and the convolution layers L1-L4. Based on the data structure described above, the attention circuits A1-A4 or B1-B4 can adaptively adjust the part that needs attention regarding the shared feature maps generated by each convolutional layer L1-L4.

In step S13, the first fusion circuit F1 selects at least two of the plurality of first attention maps to perform the first fusion operation to generate the first fusion map. In the example shown in FIG. 1, the first fusion circuit F1 selects the attention circuits A2, A3, and A4 to perform the fusion operation.

In step S14, the first classifier C1 generates the first classification result according to the first fusion map. For example, the first classifier C1 may be implemented by a fully-connected layer.

The process of steps S22-S24 is basically identical to the process of steps S12-S14, and the difference is that at least one of the plurality of second attention maps generated in step S22 is different from each of the plurality of first attention maps generated in step S21. In other words, the focuses of the attention maps are different in respect to different classification tasks.

In addition, in step S23, the second fusion circuit F2 selects three attention circuits B1, B3, and B4 to perform the fusion operation. When the classification task is different, in order to improve the classification accuracy, the required attention maps are also different. The fusion circuits F1-F2 integrates images of different levels to simulate macro and micro comprehensive consideration in human perception. In practice, the number of selected attention maps is a hyper-parameter determined by the user in advance, and at least two attention maps should be selected. Different layers in the convolutional neural network contain different information. The low-level features have more color, edge, and spatial information while the high-level features have more semantic information. The fusion map may preserve different information and enlarge the receptive field by mixing different level features. The larger receptive field contains longer-range relationships between pixels and helps the classification task. For example, the wound sizes in the medical images range from very small to very large. Although more fused layers may contain more features, it is not always beneficial to keep fusing more and more layers. The low-level features are less discriminative and might thus harm the classification accuracy when too many layers are fused. Therefore, the exact number of fused layers (i.e. the number selected attention maps) can be a hyper-parameter to tune the model.

Similarly, which attention maps outputted by the attention circuits are selected for fusion operation, the number of convolutional layers, and the number of fully connected layers in the classifier are all hyper-parameters that can be determined by the user.

In addition, it should be noticed that although FIG. 1 shows a classification system framework diagram of two classification tasks, the present disclosure does not limit the number of classification tasks adapted to the classification system. For example, the user can add a third attention network communicably connecting to the convolutional neural network CNN according to the connections between the first attention network A1 and the convolutional neural network CNN. The third attention network and the first attention network N1 share multiple shared feature maps generated by the convolutional neural network CNN. Therefore, compared to training three independent classification models, the framework proposed by the present disclosure is undoubtedly more flexible and reduces the overall data size of the classification system.

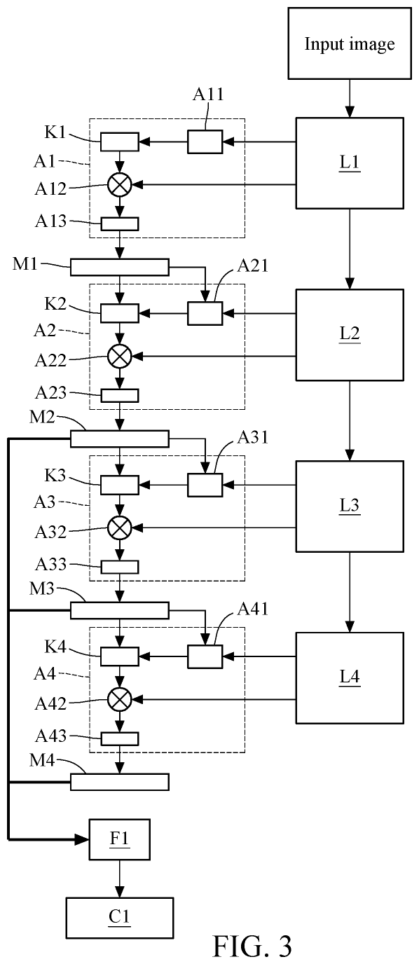

To clearly show the internal structure of the attention network, FIG. 3 shows a detailed framework diagram of a sub-architecture in FIG. 1 as an example. This sub-architecture is composed of the convolution neural network CNN, the first attention network N1, the first fusion circuit F1, and the first classifier C1. Readers should be able to understand that the sub-architecture composed of the convolutional neural network CNN, the second attention network N2, the second fusion circuit F2, and the second classifier C2 are basically identical to the sub-architecture in FIG. 3.

As shown in FIG. 3, the classification system of information in image comprises a first convolution layer L1, a second convolution layer L2, a third convolution layer L3, a fourth convolution layer L4, a first attention circuit A1, a second attention circuit A2, a third attention circuit A3, a first fusion circuit F1, and a first classifier C1.

FIG. 3 corresponds to FIG. 1. FIG. 1 shows a classification system with four convolution layers L1-L4 as an example to clearly show that the first fusion circuit F1 and the second fusion circuit F2 respectively correspond to different convolution layers. The present disclosure does not limit the maximum number of convolution layers. Depending on the user's configuration of hyper-parameters, the present disclosure may adopt more than five convolution layers. However, the minimal number of the convolution layers is three. A person of ordinary skill in the art may easily obtain a framework diagram with a different number of convolution layers according to FIG. 1 and FIG. 3.

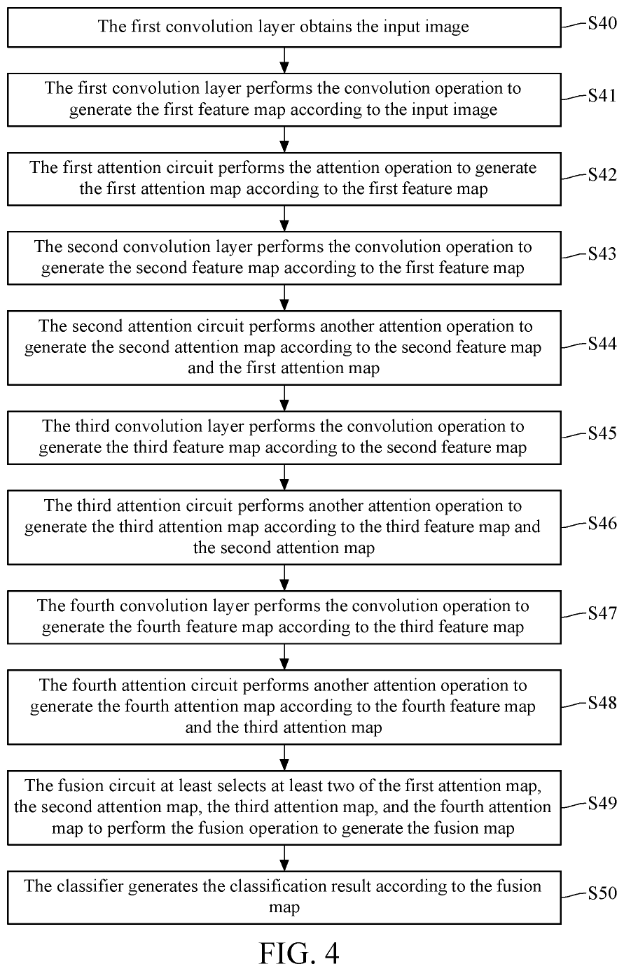

FIG. 4 is a flowchart of a classification method of information in image according to an embodiment of the present disclosure, and this flowchart corresponds to the framework diagram of FIG. 3.

As shown in FIG. 3, step S40 and step S41, the first convolution layer L1 obtains the input image and performs the convolution operation to generate the first feature map according to the input image.

As shown in FIG. 3 and step S43, the second convolution layer L2 communicably connects to the first convolution layer L1 and performs the convolution operation to generate the second feature map according to the first feature map.

As shown in FIG. 3 and step S45, the third convolution layer L3 communicably connects to the second convolution layer L2 and performs the convolution operation to generate the third feature map according to the second feature map.

As shown in FIG. 3 and step S47, the fourth convolution layer L4 communicably connects to the third convolution layer L3 and performs the convolution operation to generate the fourth feature map according to the third feature map.

The main difference between convolution operations performed by the convolution layers L1-L4 is the size of the input image and the output image of each convolution layer. The first, second, third, and fourth feature maps are not illustrated in FIG. 3.

As shown in FIG. 3 and step S42, the first attention circuit A1 communicably connects to the first convolution layer L1 and performs the attention operation to generate the first attention map M1 according to the first feature map. In an embodiment, the size of the attention map will become smaller after each operation of the attention circuit, and this means that there are fewer parts to be focused on in the image. The feature generated by the attention circuit of a higher level is more important when this feature is served as the classification determination index.

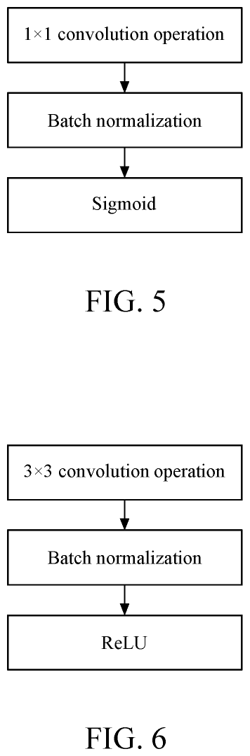

FIG. 5 is a flowchart of the attention operation. The mask generating circuit A11 in the first attention circuit A1 performs a 1×1 convolution operation on the first feature map, the result of the 1×1 convolution operation is served as an input of a batch normalization, the result of the batch normalization is inputted to a sigmoid function (S-function) for generating an attention mask K1. The value of the attention mask is a real number or {0, 1}. An example of a 3×3 attention make is shown in Table 2 below. The larger the value in the attention mask is, the higher the importance of the pixel of the feature map is, wherein the pixel of the feature map corresponds to the position represented by the value.

TABLE 2

| | | |
|---|---|---|
| 0.7 | 0.2 | 0.3 |
| 0.4 | 0.1 | 0.2 |
| 0.9 | 0.4 | 0.9 |

As shown in FIG. 3, the bitwise multiplication circuit A12 of the first attention circuit A1 performs the bitwise multiplication according to the attention mask K1 and the first feature map. Performing the bitwise multiplication is equivalent to magnifying the important pixels in the feature map with the attention mask and ignoring the unimportant pixels.

FIG. 6 is a flowchart of the dimension adjustment operation. As shown in FIG. 3, the dimension adjustment circuit A13 of the first attention circuit performs a 3×3 convolution operation on the output of the bitwise multiplication circuit A12, the output of the 3×3 convolution operation is used to perform the batch normalization, and then the result of the batch normalization is inputted to a rectified linear unit (ReLU) for generating the first attention map. In an embodiment, the dimension adjustment circuit is configured to match the channel numbers between two adjacent layers such as A1 and A2, or A2 and A3. For example, if the size of the first feature map outputted by L1 is 200×300×16 and the size of the second feature map outputted by L2 is 100×150×64, the size of M1 has to be 3×3×64 where the channel number of L2 is 64. In another embodiment, each of the dimension adjustment circuits A13-A43 further connects to a pooling layer so that the width and the height dimension of the attention maps M1-M4 can be adjusted. For example, the present disclosure uses max-pooling to down-sample on each width and height dimension respectively.

As shown in FIG. 3 and step S44, the second attention circuit A2 communicably connects to the second convolution layer L2 and the first attention circuit A1 and performs another attention operation to generate the second attention map M2 according to the second feature map and the first attention map M1.

As shown in FIG. 3 and step S46, the third attention circuit A3 communicably connects to the third convolution layer L3 and the second attention circuit A2 and performs another attention operation to generate the third attention map M3 according to the third feature map and the second attention map M2.

As shown in FIG. 3 and step S48, the fourth attention circuit A4 communicably connects to the fourth convolution layer L4 and the third attention circuit A3 and performs another attention operation to generate the fourth attention map M4 according to the fourth feature map and the third attention map M3.

The detailed architectures of the second attention circuit A2, the third attention circuit A3, and the fourth attention circuit A4 are basically identical. Here, the second attention circuit A2 is taken as an example and explained as follows. The process of said another attention operation is basically identical to the process of the attention operation shown in FIG. 5. The mask generating circuit A21 of the second attention circuit A2 performs the 1×1 convolution operation, the batch normalization, and the S-function sequentially to generate the attention mask K2. The bitwise multiplication circuit A22 of the second attention circuit A2 performs the bitwise multiplication according to the attention mask K2 and the first feature map.

As shown in FIG. 6, the dimension adjustment circuit A23 of the second attention circuit A2 performs the 3×3 convolution operation on the output of the bitwise multiplication circuit A22, the result of the 3×3 convolution operation is used to perform the batch normalization, and the output of the batch normalization is inputted to the ReLU to generate the second attention map M2.

Overall, each of the attention circuits A1-A4 first generates each of the attention masks K1-K4 according to each of the shared feature maps outputted by each of the convolution layers L1-L4 and the attention map (if exists) of the previous level of attention circuits, then performs the mask operation (bitwise multiplication) according to the attention mask and the shared feature map, and performs the dimension adjustment to generate an attention map according to the result of the mask operation.

As shown in FIG. 3, the fusion circuit F1 at least communicably connects to at least two of the first attention circuit A1, the second attention circuit A2, the third attention circuit A3, and the fourth attention circuit A4. In the example of FIG. 3, the fusion circuit F1 communicably connects to the second attention circuit A2, the third attention circuit A3, and the fourth attention circuit A4. In step S49, the fusion circuit F1 at least selects at least two of the first attention map M1, the second attention map M2, the third attention map M3 and the fourth attention map M4 to perform the fusion operation to generate the fusion map. In the example of FIG. 3, the fusion circuit F1 selects the second attention map M2, the third attention map M3 and the fourth attention map M4 to perform the fusion operation.

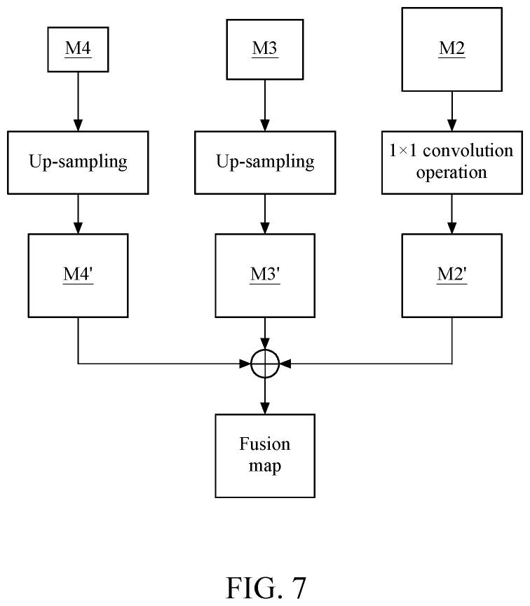

FIG. 7 is a schematic diagram of an embodiment of the fusion operation. Taking the example of FIG. 3, the second attention map M2 is the attention map of a lower layer, so its size is larger and its number of channels is smaller, and the fourth attention map M4 is the attention map of a higher layer, so its size is smaller and its number of channels is larger. Therefore, before the fusion circuit merges the three attention maps M2-M4, it is necessary to perform the image normalization operation to generate M2′-M4′, and then perform the image mix operation. The image normalization operation comprises size adjustment and channel number adjustment. Based on the attention map M2 with the largest size, the size adjustment performs an up-sampling operation on the attention maps M3 and M4 with smaller sizes, so that the sizes of the two attention maps M3 and M4 are identical to the size of the attention map M2. Based on the attention map M4 with the maximum number of channels, the channel number adjustment provides a larger number of convolution kernels to perform a 1×1 convolution operation on the attention maps M2 and M3 with smaller numbers of channels, so that the numbers of channels of the two attention maps M2 and M3 are identical to the number of channels of the attention map M4.

Another embodiment of channel number adjustment is to adjust the number of channels of all attention maps M2 to M4 downward to the same value. This value may be less than the minimum number of channels in the attention map M2-M4. The specific implementation of the downward adjustment is also through the 1×1 convolution operation, and by providing a smaller number of convolution kernels to achieve the dimensionality reduction operation on all the attention maps M2-M4.

Two embodiments of the mix operation comprise a bit-scale addition operation or a concatenation operation.

In view of the above, there are two implementations in the image normalization operation (size upward adjustment and channel number upward adjustment, size upward adjustment, and channel number downward adjustment), and there are two implementations in the mix operation (addition operation, concatenation operation). Therefore, there are four methods to implement the fusion operation described in step S50, each is a combination of one of the implementation methods of the image normalization operation and one of the implementation methods of the mix operation.

As shown in FIG. 3 and step S50, the classifier C1 communicably connects to the fusion circuit F1 and generates a classification result according to the fusion map. The classifier C1 may, for example, adopt the form of a fully connected layer of “512→64→2” and finally generate a binary classification result.

It should be noticed that the process in FIG. 4 may also complete the feature map extraction process of the convolutional neural network CNN first, and then perform the attention map generation process of the attention network, as shown in the following execution process:

### S40→S41→S43→S45→S47→S42→S44→S46→S48→S49→S50.

The following describes a process using only three convolution layers and three attention circuits to perform the classification method of information in image of the present disclosure. The first convolution layer obtains an input image. The first convolution layer performs a convolution operation to generate a first feature map according to the input image. The first attention circuit performs an attention operation to generate a first attention map according to the first feature map. The second convolution layer performs the convolution operation to generate a second feature map according to the first feature map. The second attention circuit performs another attention operation to generate a second attention map according to the second feature map and the first attention map. The third convolution layer performs the convolution operation to generate a third feature map according to the second feature map. The third attention circuit performs said another attention operation to generate a third attention map according to the third feature map and the second attention map. The fusion circuit selects at least two of the first attention map, the second attention map, and the third attention map to perform a fusion operation to generate a fusion map. The classifier generates a classification result according to the fusion map.

In view of the above, the classification system of information in image proposed by the present disclosure is equivalent to a multi-task learning system. The present disclosure shares the extracted features by adopting the attention mechanism and performs multiple classification tasks by image hierarchical structure.

The classification system of information in image proposed by the present disclosure may store the trained model and attention network on a remote server. Users working at the local end may take physiological images through smartphones or webcams, and then return the images to the server's classification system for diagnosis. Another embodiment is to store a lightweight attention network on the local end such as a mobile phone, and store multiple feature maps generated by the convolutional neural network on the remote server. The medical image diagnosis assisted by artificial intelligence may be achieved in the form of edge computing through the mobile phone application interacting with the network service provided by the server.

The present disclosure adopts the multi-task discipline and shares features among different tasks. In order to make the system proposed by the present disclosure general enough to leverage shared featured of different tasks and also subtle enough to capture the differences between tasks, the present disclosure adopts the attention network architecture. The proposed framework takes into account the multi-level hierarchy of image data. It captures coarse image features as well as fine image features.

What is claimed is:

1. A classification method of information in image comprising:
obtaining an input image by a convolution neural network and generating a plurality of shared feature maps;
generating a plurality of first attention maps by a first attention network according to the plurality of shared feature maps;
selecting at least two of the plurality of first attention maps to perform a first fusion operation to generate a first fusion map by a first fusion circuit; and
generating a first classification result according to the first fusion map by a first classifier.

2. The classification method of information in image of claim 1, further comprising:
generating a plurality of second attention maps according to the plurality of shared feature maps by a second attention network;
selecting at least two of the plurality of second attention maps to perform a second fusion operation to generate a second fusion map by a second fusion circuit; and
generating a second classification result according to the second fusion map by a second classifier; wherein
at least one of the plurality of second attention maps is different from each of the plurality of first attention maps.

3. A classification method of information in image comprising:
obtaining an input image by a first convolution layer;
performing a convolution operation to generate a first feature map according to the input image by the first convolution layer;
performing an attention operation to generate a first attention map by a first attention circuit according to the first feature map;
performing the convolution operation to generate a second feature map according to the first feature map by a second convolution layer;
performing another attention operation to generate a second attention map according to the second feature map and the first attention map by a second attention circuit;
performing the convolution operation to generate a third feature map according to the second feature map by a third convolution layer;
performing said another attention operation to generate a third attention map according to the third feature map and the second attention map by a third attention circuit;
selecting at least two of the first attention map, the second attention map, and the third attention map to perform a fusion operation to generate a fusion map by a fusion circuit; and
generating a classification result according to the fusion map by a classifier.

4. The classification method of information in image of claim 3, wherein performing the attention operation according to the first feature map to generate the first attention map by the first attention circuit comprises:
sequentially performing a 1×1 convolution operation, a batch normalization, and an S-function to generate an attention mask by the first attention circuit; and
performing at least a bitwise multiplication to generate the first attention map according to the attention mask and the first feature map by the first attention circuit.

5. The classification method of information in image of claim 3, wherein performing said another attention operation according to the second feature map and the first attention map to generate the second attention map by the second attention circuit comprises:
sequentially performing a 1×1 convolution operation, a batch normalization, and an S-function to generate an attention mask by the second attention circuit; and
performing at least a bitwise multiplication to generate the second attention map according to the attention mask and the second feature map by the second attention circuit.

6. The classification method of information in image of claim 3, wherein selecting at least two of the first attention map, the second attention map, and the third attention map to perform the fusion operation to generate the fusion map by the fusion circuit comprises:
adjusting sizes of said at least two attention maps to be identical;
adjusting numbers of channels of said at least two attention maps to be identical; and
performing a mix operation on said at least two attention maps whose sizes and numbers of channels have been adjusted.

7. A classification system of information in image comprising:
a first convolution layer obtaining an input image and performing a convolution operation to generate a first feature map according to the input image;
a second convolution layer communicably connecting to the first convolution layer and performing the convolution operation to generate a second feature map according to the first feature map;
a third convolution layer communicably connecting to the second convolution layer and performing the convolution operation to generate a third feature map according to the second feature map;
a first attention circuit communicably connecting to the first convolution layer and performing an attention operation to generate a first attention map according to the first feature map;
a second attention circuit communicably connecting to the second convolution layer and the first attention circuit, and performing another attention operation to generate a second attention map according to the second feature map and the first attention map;
a third attention circuit communicably connecting to the third convolution layer and the second attention circuit, and performing said another attention operation to generate a third attention map according to the third feature map and the second attention map;
a fusion circuit at least communicably connecting to at least two of the first attention circuit, the second attention circuit and the third attention circuit, and performing a fusion operation to generate a fusion map at least according to at least two of the first attention map, the second attention map and the third attention map; and
a classifier communicably connecting to the fusion circuit and generating a classification result according to the fusion map.
